(19) United States
(12) Patent Application Publication
(10) Pub. No.: US 2007/0201643 A1
(43) Pub. Date: Aug. 30, 2007

(54) Cost-free calling system and method

(76) Inventors: Tracie Z. Eisenman, San Jose, CA (US); David A. Greenlee, Columbus, OH (US)

Correspondence Address: DAVID A. GREENLEE, P.O. BOX 340557, COLUMBUS, OH, 43234, US

(21) Appl. No.: 11/644,300

(22) Filed: Dec. 22, 2006

Related U.S. Application Data
(60) Provisional application No. 60/752,859, filed on Dec. 22, 2005.

(51) Int. Cl. H04M 15/00

(52) U.S. Cl. 379/114.21

(57) ABSTRACT

A telephone service that is completely free to the cell phone user provides a billing arrangement between a called party and a cellular service provider in which the called party agrees to assume all costs for calls to the called party by any cellular caller who is a customer of the cellular service supplier. Billing data for a cellular call from a caller to the called party is automatically captured by a logging computer for use by the cellular service provider to credit the caller for any charges normally associated with said call, and bill the called party for the call.

### RELATED APPLICATION

This application claims the priority of U.S. Provisional Patent Application No. 60/752859, filed Dec. 22, 2005.

### TECHNICAL FIELD

This invention relates to a calling system in which a cell phone caller is able to place a call to a called party (e.g. commercial source) without incurring any long distance charges or usage minutes.

### BACKGROUND OF THE INVENTION

In the typical “800” WATS service, only the long distance charges are assumed by the called party. The other call costs (e.g. cell phone usage charges) are borne by the caller. The monitoring and control equipment is able to distinguish the caller's service provider (e.g. AT&T, Sprint, Cingular, etc.) to properly credit the caller for the long distance charges. Cell phone usage is measured in minutes which are usually limited to a maximum amount determined by the particular plan subscribed by the cell phone user. Minutes are charged to the cell phone user for both incoming and outgoing calls. Thus, an “800” call costs the cell phone caller the minutes actually used during the call and is not completely “free” to the cell phone caller.

Also, the “800” WATS service is becoming increasingly irrelevant, because cell phone service often comes with free long-distance as a standard feature, and cell phone use continues to rise dramatically, increasingly supplanting landline use.

Many systems have been proposed to provide for authorizing specified cell phones to call certain specified cell phone numbers with costs being borne by the authorizing party. These are proposed for businesses that have employees using cell phones for business purposes. These systems require codes to be dialed during the call. These are so-called “calling party pays” systems in which the calling party business pays for calls made by certain identified callers to specified parties. The mobile network has the ability to recognize the identity of designated called cell phone numbers and charge the calling party for all airtime charges. One of these is disclosed in Pat. No. 6,397,055—McHenry et al in which a “calling party pays” service is provided for a mobile call originating from a prepaid mobile user. This requires prepayment or subscription to finance the calls.

It would be desirable in the business world to provide a service which supplants the “800” service and in which all charges, both long distance and usage charges, are paid for by a called party to be completely free for the cell phone caller.

### SUMMARY OF THE INVENTION

What is needed is a service that provides a service that is completely free to the cell phone user and is completely paid by the called party. Such an arrangement would stimulate any business that provides such a service.

Since many cell phone plans feature free long distance, the is no advantage for a cell phone user to call a toll-free “800” number, since there is no toll charge for the cell phone user. This invention provides a cost-free service for a business to enhance their local trade. Since cell phone usage has largely supplanted land line usage amongst youth and young adults, many youth-oriented businesses such as a pizza and other take-out restaurants, would benefit from such a service.

This invention contemplates the provision of an extra phone line that a business can set up to generically absorb all related charges from any cell phone customer, whether from across the country or across the block. A cost-free cell-friendly number, here called a “Z-Line”, would be provided for anyone, especially cell phone users, to call. The business owner would contract to register the Z-Line phone number with each of the cell service providers. Incoming cell calls to would be logged and reported to the provider for the caller, which would credit the caller for the air time and charge the business (i.e. the called party). Due to volume, the called party business owner could negotiate a reduced fee for these calls—benefiting the business owner. Also, this service would stimulate cell phone usage, since the call is free of airtime charges to the caller, cell phone usage and thus result in increased revenues for the cell service provider. It is anticipated the market for this service will become attractive to many retail businesses, e.g. real estate, retail, restaurants (take-out, reservations) and, perhaps, to many other industries, e.g. education or libraries, where information is sought.

The essence of the invention is the provision of a method and a system for enabling cell phone callers to place cost-free (as opposed to toll-free) calls to businesses and other destinations.

In one aspect, this invention features a method of cost-free telephone calling which enables all costs of a phone call from a cell phone caller to a called party to be borne by the called party, comprising the steps of

establishing a financing arrangement between the called party and a cell phone service provider for the caller,

logging information about a telephone call from the caller to the called party on a computer and transmitting the logged information to the cell phone service provider,

crediting the costs of the telephone call to the caller so that the call is cost-free to the caller, and

charging the cost of the call to the called party.

In another aspect, this invention features such a method that further includes the steps of establishing a financing arrangement between the called party and a plurality of different cell phone service providers, and transmitting the logged information to the cell phone provider of the service used by each caller.

In a further aspect, this invention features a method of billing for cellular telephone calls, comprising the steps of forming a billing arrangement between a designated called party and a cellular service provider in which the called party agrees to assume all costs for calls to the designated party by any cellular caller who is a customer of the cellular service supplier, capturing billing data for a cellular call from a caller to the designated called party on a computer for use by the cellular service provider, using the billing data to credit the caller for any charges normally associated with said call, and billing the designated called party for the call. In a yet further aspect, this invention features modifying this method by inserting a third party into the arrangement to contract separately with the cellular service provider and the designated called party.

These and other objects and features of this invention will become more readily apparent upon reference to the following detailed description of a preferred embodiment, as illustrated in the accompanying drawings, in which:

### BRIEF DESCRIPTION OF THE DRAWINGS

FIG. 1 is a schematic diagram of a first embodiment of calling system according to this invention, illustrating a single cell caller, single call log and a single cell service provider;

FIG. 2 is a schematic diagram of a second embodiment, similar to FIG. 1, but showing a plurality of callers, call logs and service providers; and

FIG. 3 is a schematic diagram of a third embodiment, similar to FIG. 2, but illustrating a plurality of callers and service providers, but a single call log.

### DESCRIPTION OF THE PREFERRED EMBODIMENT

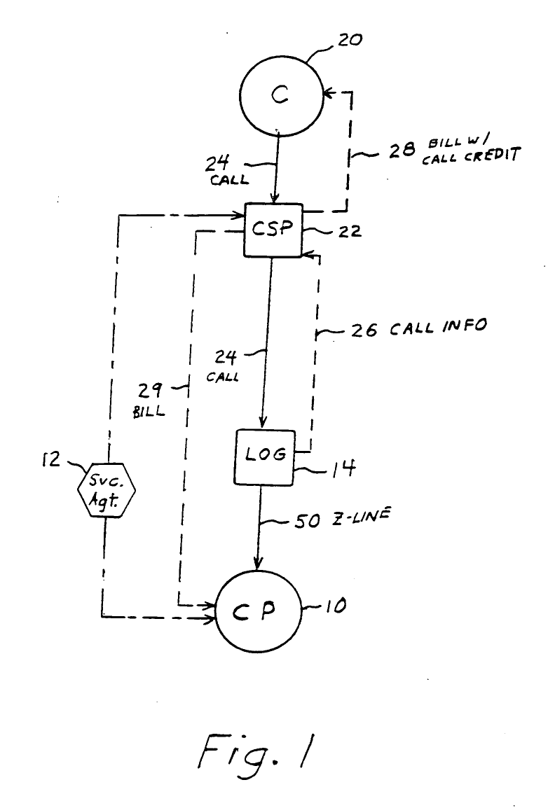

Referring now to FIG. 1, a business, such as a pizza delivery service, restaurant, real estate broker, retail store, etc., here termed a “called party” (CP) 10, desires to provide a cost-free call-in telephone service to potential customers, such as cell phone Caller 20, as a way to stimulate business, much in the way the “800 WATS” service is used to stimulate business by providing toll-free calling for callers. Cell phone Caller 20 uses Cellular Service Provider (CSP) 22 to provide his cell phone service. CSP 22 and CP 10 then execute a service agreement to provide the service according to this invention, whereby Caller 20 can call CP 10 from anywhere, be it across the block or across the country, without cost to Caller 20; call costs would be borne by CP 10.

The agreement between CP 10 and CSP 22 would provide that the air time (minutes) used by Caller 20 would be credited back, and any long distance toll charges would not apply. The cost of the call—toll charges, if any, and air time—would be billed back to CP 10. It is anticipated that CSP 22 would sweeten the deal by discounting the charges from the amount credited to Caller 20, as is done with WATS services to make them affordable to CP 10, thus stimulating business volume for both CSP 22 and CP 10 businesses. As a result of this agreement, a special telephone number or line, called a “Z-Line” 50, is allocated to CP 10 to handle these calls.

In this scenario, Caller 20 places a call to CP 10's Z-Line via CSP22. The Z-Line number is recognized by a logging computer, or Log 14 and the call is automatically logged. In this embodiment, Log 14 could be captive computer equipment owned by and located at CSP 22, or could be owned by CP 10 or a separate logging service. Upon call completion, call information 26, in the form details of the call (i.e. Caller, Z-Line number, duration), is conveyed to CSP 22. Thereafter, CSP 22 posts a credit 28 to the account of Caller 10 for airtime and any toll charges to offset the normal billing for the call. CSP 22 also then bills the cost of the call 29 to the account of CP 10, according the subscription agreement.

As a result, Caller 20 feels free to call CP 20 to order pizza or merchandise, make a dinner reservation, or obtain information without fear of exhausting the limited monthly “minutes” allotment according to his agreement with CSP 22.

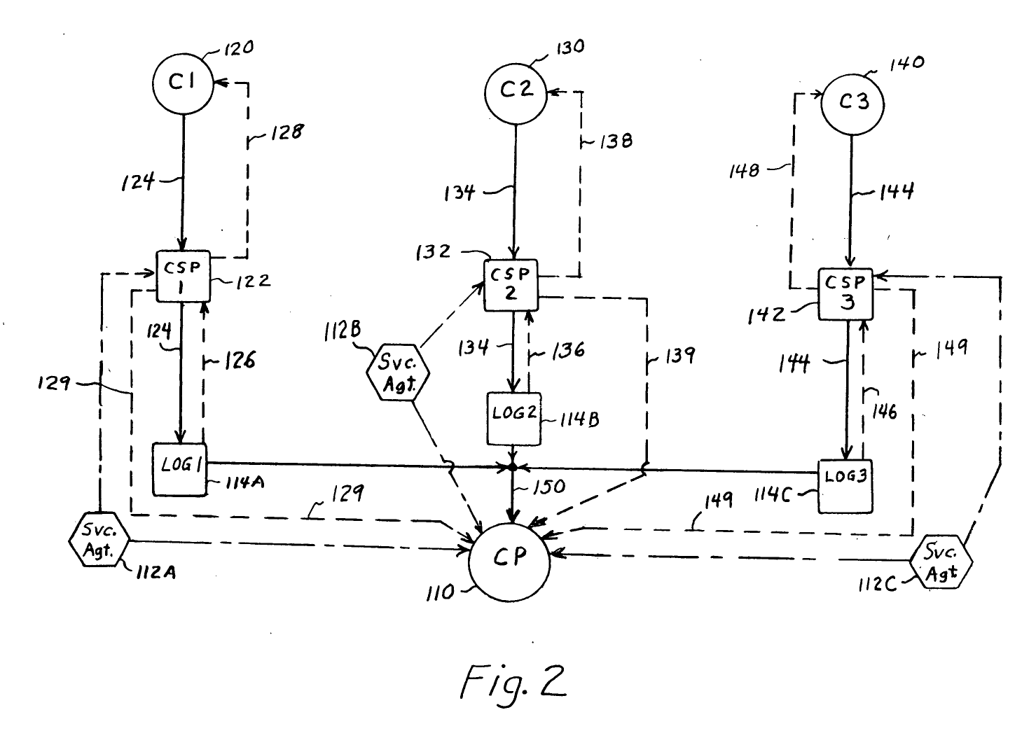

Another embodiment is illustrated in FIG. 2, where similar or the same elements bear the same reference numeral as in FIG. 1, but increased by 100. Here, the arrangement of FIG. 1 is triplicated. CP 110 has established billing arrangements 112A, 112B, 112C with each of three separate CSPs 122, 132,142. Calls 124, 134, 144 from each of their customers, here represented by respective Callers 120, 130, 140, are automatically logged by call Logs 114A, 114B, 114C and ring in on CP 20's “Z-line” 150. Respective call or billing data 126, 136, 146 for these calls is transmitted to CSPs 122, 132, 142 so that Callers 120, 130, 140 are credited for all normal costs of the call that they have incurred. If the Log computers are an integral part of the CSPs, the charges would be automatically suppressed or offset. These calls 124, 134, 144 are then charged (129, 129, 149) to C P 110 in accordance with the terms of each of the billing arrangements 112A, 112B, 112C.

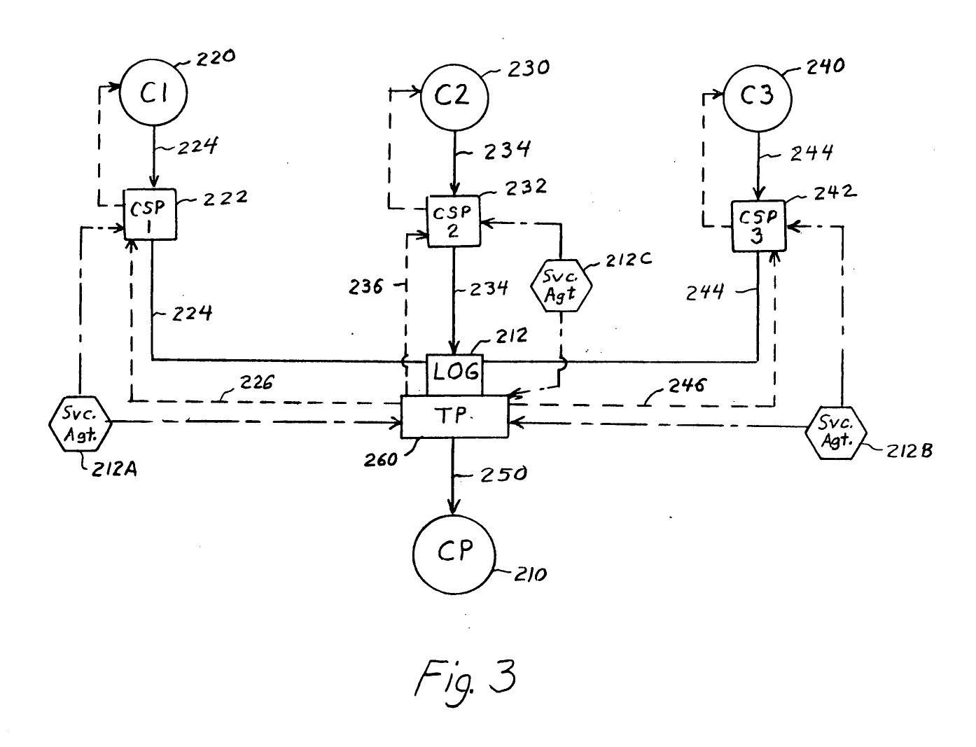

Yet another embodiment of this invention is illustrated in FIG. 3, where elements similar to those of FIGS. 1 bear the same reference numeral as in FIG. 1, but increased by 200. In this embodiment, three representative Callers, CSPs and CPs are illustrated. Thus, CSPs 222, 232, 242 have representative Callers 220, 230, 240, all desirous of placing cost-free calls 224, 234, 244 to the “Z-Iines” 250A, 250B, 250C of CPs 210A, 210B, 210C.

It is anticipated that the volume of business generated, the large number of prospective CPs, and the large number of existing CSPs will entice third parties to enter the business to act as a specialist intermediary, representing one or more CSPs, performing the automatic computer call logging function and signing up a multiplicity of CPs. Thus, here a Third Party TP 260 is interposed between CSPs 222, 232, 242 and operates a consolidated call log 212 that services the “Z-lines” 250A, 250B, 250C for all of CPs 210A, 210B, 210C.

By consolidating the call logging function, it is anticipated that TP 260 could negotiate bulk rates with the CSPs, thus lowering the cost of the service to CPs. This would enable a proliferation of an economical cost-free service for use by businesses to entice calls from cell phone callers.

While only preferred embodiments have been described and shown, obvious modifications are contemplated within the scope of this invention as set forth in the appended claims.

1. A method of cost-free telephone calling which enables all costs of a phone call from each of a plurality of cell phone callers to a called party to be borne by the called party, comprising the steps of
a. establishing a billing arrangement between the called party and a cell phone service provider for the callers,
b. automatically logging information about a telephone call from the callers to the called party and transmitting the logged information to the cell phone service provider,
c. crediting the costs of the telephone call to the callers so that the call is cost-free to the caller, and
d. charging the cost of the call to the called party.

2. The method of claim 1, including the steps of
e. establishing a billing arrangement between the called party and a plurality of different cell phone service providers, and
f. transmitting the logged information to the cell phone provider of the service used by each caller.

3. A method of billing for cellular telephone calls, comprising the steps of
a. forming a billing arrangement between a called party and a cellular service provider in which the called party agrees to assume all costs for calls to the called party by any cellular caller who is a customer of the cellular service supplier,
b. automatically capturing billing data for a cellular call from a caller to the called party for use by the cellular service provider,
c. using the billing data to credit the caller for any charges normally associated with said call, and
d. billing the called party for the call.

4. The method of claim 3, including the steps of
stablishing a billing arrangement between the called party and a plurality of different cell phone service providers, and
ransmitting the logged information to the cell phone provider of the service used by each caller.

5. The method of claim 4, including the further step of providing a third party to contract separately with the cellular service providers and with the designated called party to log and bill the calls.
